(19) United States
(12) Patent Application Publication
(10) Pub. No.: US 2018/0074446 A1
(43) Pub. Date: Mar. 15, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Takao IZUMI, Yokohama Kanagawa (JP)

(21) Appl. No.: 15/681,629

(22) Filed: Aug. 21, 2017

(30) Foreign Application Priority Data
Sep. 13, 2016 (JP) 2016-178785

(51) Int. Cl. G03G 15/20

(52) U.S. Cl. CPC G03G 15/2078; G03G 2215/2038; G03G 2215/2019; G03G 15/2039

(57) ABSTRACT

According to one embodiment, an image forming apparatus includes a printer device, a fixing device, an input interface, and a controller. The controller executes a temperature-change process where the controller determines that it is necessary to change the target temperature of the fixing device on the basis of the image-forming instruction input from the input interface, the temperature-change process including changing the target temperature of the fixing device to a new target temperature. Further, the controller controls the printer device to start an image-forming process on the basis of the image-forming instruction after the temperature-change process.

### CROSS-REFERENCE TO RELATED APPLICATION

This application is based upon and claims the benefit of priority from the prior Japanese Patent Application No. 2016-178785, filed on Sep. 13, 2016, the entire contents of which are incorporated herein by reference.

### FIELD

An embodiment to be described here generally relates to an image forming apparatus.

### BACKGROUND

In some image forming apparatuses, the fixable temperature range, in which a toner image is fixable on a sheet, is different depending on the kind of toner and the kind of sheet. Because of this, where an image forming apparatus controls a fixing device to control the temperature of the fixing device in a certain fixable temperature range and forms an image in a different fixable temperature range in this status, the image forming apparatus starts to change the temperature of the fixing device to a target temperature, the target temperature being a temperature in the fixable temperature range.

The image forming apparatus starts to change the temperature of the fixing device and, in addition, starts to drive photosensitive drums, to drives developer devices, to convey sheets, and the like. After that, when the temperature of the fixing device reaches the target temperature, the image forming apparatus starts the image-forming process including exposing and the like.

As described above, the image forming apparatus of a related art drives the photosensitive drums and the developer devices after the image forming apparatus starts to change the temperature of the fixing device to the target temperature and until the temperature of the fixing device reaches the target temperature. The photosensitive drums, the developer devices, and the like are expendable components expendable in image formation. As a result, in the related art, such expendable components have shorter lifetime, which is a problem.

### BRIEF DESCRIPTION OF THE DRAWINGS

FIG. 1 is a partial cross-sectional view showing an entire image forming apparatus of an embodiment.

FIG. 2 is a cross-sectional view showing a fixing device according to the present embodiment.

FIG. 3 is a block diagram showing the image forming apparatus according to the present embodiment.

FIG. 4 is a flowchart showing the flow of the image-forming process according to the present embodiment.

FIG. 5 is a flowchart showing the flow of the image-forming process according to the present embodiment.

### DETAILED DESCRIPTION

According to one embodiment, an image forming apparatus includes a printer device, a fixing device, an input interface, and a controller. The printer device forms an image on a sheet. The fixing device heats the sheet, on which the image is formed by the printer device, at a variable target temperature to thereby fix the image on the sheet. The input interface that inputs an image-forming instruction. The controller determines whether it is necessary to change the target temperature of the fixing device on the basis of the image-forming instruction input from the input interface. The controller executes a temperature-change process where the controller determines that it is necessary to change the target temperature of the fixing device, the temperature-change process including changing the target temperature of the fixing device to a new target temperature. Further, the controller controls the printer device to start an image-forming process on the basis of the image-forming instruction after the temperature-change process.

According to the image forming apparatus according to the present embodiment, expendable components may have longer lives. Hereinafter, an image forming apparatus of an embodiment will be described in detail with reference to the drawings. In the drawings, the same reference symbols indicate the same or similar units.

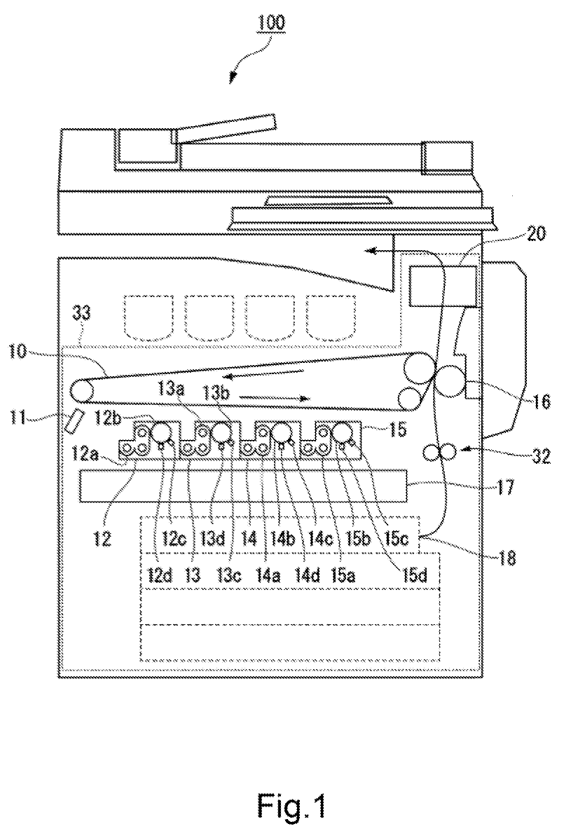

FIG. 1 is a diagram showing an image forming apparatus 100 of an embodiment. The image forming apparatus 100 of FIG. 1 is an electrophotographic image forming apparatus. The image forming apparatus 100 includes the printer device 33, the controller 17, the sheet-feeding device 18, and the fixing device 20. The printer device 33 includes the intermediate transfer member 10, the blade 11 (toner remover unit), the image forming units 12, 13, 14, and 15, the resist rollers 32, the secondary transfer rollers 16, and the like. The controller 17 controls the image forming apparatus 100. The printer device 33 forms an image on a sheet.

The image forming apparatus 100 forms electrostatic latent images on the photosensitive drums 12b, 13b, 14b, and 15b on the basis of image data. Further, the image forming apparatus 100 causes developers to adhere to the electrostatic latent images to thereby form visible images. In the present embodiment, for a specific example, toners are used as the developers.

The intermediate transfer member 10 is an endless belt. The intermediate transfer member 10 rotates in the direction of the arrows of FIG. 1 while holding the images of toners (hereinafter, sometimes simply referred to as toner images) transferred from image holding members. The blade 11 removes toners, which adhere to the intermediate transfer member 10, after the toner images are transferred to the sheet. The image forming units 12 to 15 form images (toner images) on the image holding members by using toners of the respective colors (four colors in the example of FIG. 1). The sheet, on which the images are to be formed, is conveyed, by the resist rollers 32 and the like, to the transfer position by the secondary transfer rollers 16. The secondary transfer rollers 16 transfers the toner images formed on the intermediate transfer member 10 on the sheet.

The controller 17 controls the image forming units 12 to 15 and the fixing device 20. The sheet-feeding device 18 conveys the sheet to the secondary transfer rollers 16 of the printer device 33. The fixing device 20 fixes the toner images on the sheet. Specifically, the fixing device 20 heats at a variable target temperature and presses the sheet on which the toner images are formed by the printer device 33 to thereby fix the images (toner images) on the sheet. The target temperature is, for example, any temperature in the temperature range in which toner images is fixable on a sheet. In addition, the target temperature is the target of the temperature controlled such that the temperature of the fixing device 20 is in the fixable temperature range. Further, the fixable temperature range is different depending on the kind of toner and the kind of sheet. Accordingly, the target temperature is different depending on the kind of toner and the kind of sheet.

The image forming apparatus 100 converts image data, on which images are formed, to image data of the respective colors by means of image processing. The image forming apparatus 100, for example, converts image data into image data of respective colors, i.e., yellow (Y), magenta (M), cyan (C), and black (K). The image forming units 12 to 15 are for the above-mentioned respective colors (described later). The image forming units 12 to 15 primary-transfer toner images of the respective colors on the intermediate transfer member 10. In other words, in the primary-transfer, the image forming units 12 to 15 multi-transfer the toner images of the respective colors, overlapped with each other in order, on the intermediate transfer member 10. Next, the secondary transfer rollers 16 transfers the toner images on the intermediate transfer member 10 to the sheet. The secondary transfer rollers 16 is an example of a transfer device.

The sheet is fed from the sheet-feeding device 18, and is conveyed on the sheet conveying path. The sheet passes through the secondary transfer rollers 16 and the fixing device 20, and is discharged to a discharge tray.

Next, the image forming units 12 to 15 will be described. The image forming units 12 to 15 form toner images on image holding members, and primary-transfer the toner images from the image holding members to the intermediate transfer member 10. Specifically, the image forming unit 12 forms a black toner image on an image holding member. The image forming unit 13 forms a yellow toner image on an image holding member. The image forming unit 14 forms a magenta toner image on an image holding member. The image forming unit 15 forms a cyan toner image on an image holding member. Since the structure of the image forming units 12 to 15 are the same except for the different developers (toners) therein, the image forming unit 12 will be described for an example.

The image forming unit 12 includes the developer device 12a, the photosensitive drum 12b, the charging device 12c, the exposing device 12d, and the like. The developer device 12a causes the toner to adhere to the photosensitive drum 12b, and thereby develops an electrostatic latent image formed on the photosensitive drum 12b. The photosensitive drum 12b is an image holding member. The photosensitive drum 12b has photoreceptors (photosensitive area) on its outer circumferential surface. The photoreceptors are, for example, organic photo conductors (OPC). The charging device 12c electrically charges the surface of the photosensitive drum 12b uniformly. The exposing device 12d irradiates the photosensitive drum 12b with light, and thereby exposes the photosensitive drum 12b to light. The exposing device 12d exposes the photosensitive drum 12b to light, and thereby forms an electrostatic latent image. The exposing device 12d includes a light source for exposure such as laser and LED.

The photosensitive drum 12b is electrically charged by the charging device 12c. Next, the photosensitive drum 12b is exposed to light by the exposing device 12d on the basis of image data of each color. As a result, an electrostatic latent image is formed on the surface of the photosensitive drum 12b. The electrostatic latent image corresponds to image data of each color. The electrostatic latent image on the photosensitive drum 12b is developed by the developer device 12a. In other words, a toner image is formed on the surface of the photosensitive drum 12b. The toner image on the photosensitive drum 12b is primary-transferred to the intermediate transfer member 10 by means of the field effect, for example.

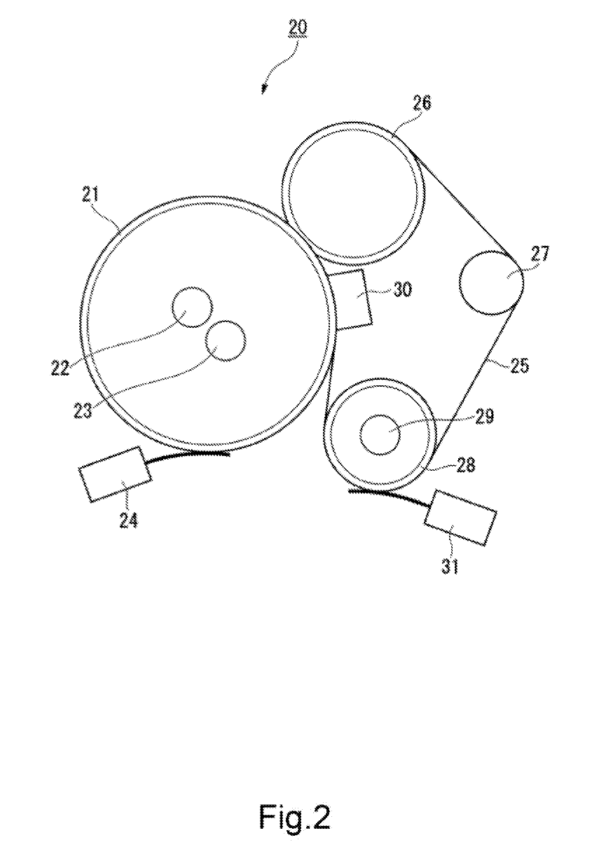

FIG. 2 is a diagram schematically showing the structure of the fixing device 20 of FIG. 1. The fixing device 20 includes the heat roller (fix roller) 21, the HR center lamp 22, the HR side lamp 23, the HR thermistor (fix roller thermistor) 24, pressure belt 25, the outlet pressure roller 26, the tension roller 27, the pressure belt heat roller 28, the pressure belt lamp 29, the nip pad 30, and the pressure belt thermistor 31. The heat roller 21 is a specific example of a heater. The heat roller 21 is heated by a heat generating member equipped therein. The heat roller 21 includes the HR center lamp 22 and the HR side lamp 23 in a space thereof.

Further, the HR center lamp 22 and the HR side lamp 23 are, for example, heating sources such as halogen lamps. Note that the power consumed by two of the HR center lamp 22 and the HR side lamp 23 is 600 W. The HR center lamp 22 heats a center portion of the heat roller 21 in a longitudinal direction. The HR side lamp 23 heats end portions of the heat roller 21 in the longitudinal direction. The HR thermistor 24 detects the temperature of the heat roller 21.

The pressure belt 25 is an endless belt. The pressure belt 25 surrounds the outlet pressure roller 26, the tension roller 27, and the pressure belt heat roller 28 thereby stretching around the three rollers. The tension roller 27 applies tension to the pressure belt 25.

The pressure belt heat roller 28 performs heating using a built-in heat generating member. The pressure belt heat roller 28 has the pressure belt lamp 29 as the built-in heat generating member. The pressure belt lamp 29 heats the pressure belt heat roller 28. The pressure belt 25 is heated by the heat transferred from the pressure belt heat roller 28. The pressure belt lamp 29 is, for example, a heating source such as a halogen lamp. In the specific example of FIG. 2, the pressure belt lamp 29 is a halogen lamp of which energy consumption is 300 W.

The nip pad 30 is biased by an independent pressure mechanism (not illustrated) provided inside the pressure belt 25 in the direction toward the heat roller 21 direction. The nip pad 30 presses the pressure belt 25 against the outer circumferential surface of the heat roller 21 from the inner side of the pressure belt 25 by making use of the biasing force. The pressure belt 25 and the heat roller 21 are in press-contact by the nip pad 30. The pressure belt thermistor 31 detects the temperature of the pressure belt 25. The pressure belt thermistor 31 is arranged at the center part of the pressure belt 25 in a width direction.

The sheet and the toner images thereon are heated and pressed when the sheet passes through a nip between the heat roller 21 and the pressure belt 25. The sheet passing through the nip is heated from the both sides of the heat roller 21 and the pressure belt 25. Accordingly, toner images are fixed on the sheet.

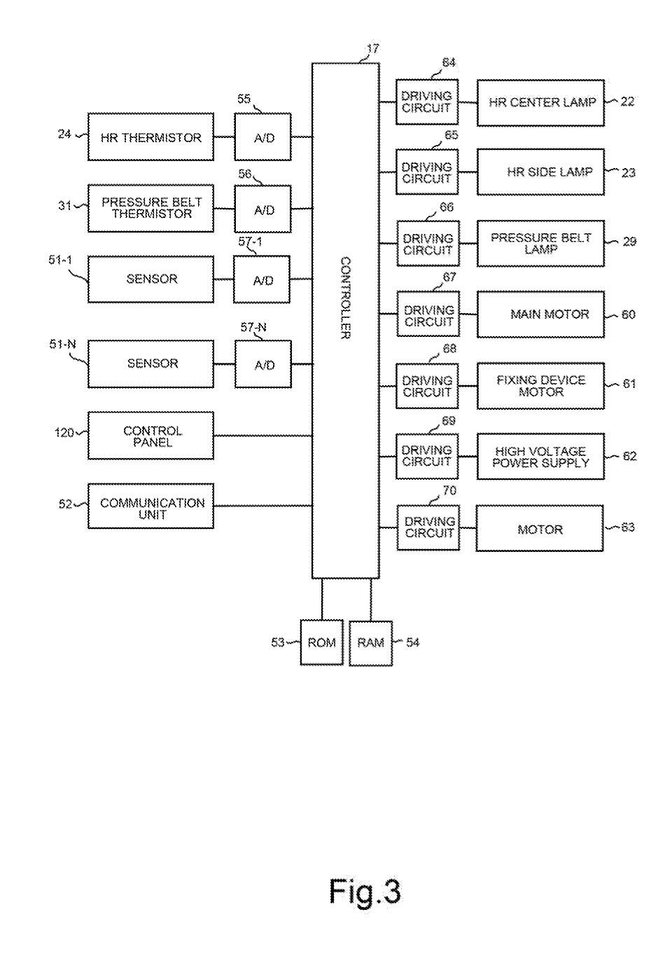

FIG. 3 is a block diagram showing the image forming apparatus 100 according to the present embodiment. As described above, the image forming apparatus 100 includes the control panel 120, the HR center lamp 22, the HR side lamp 23, the HR thermistor 24, the pressure belt lamp 29, and the pressure belt thermistor 31. The image forming apparatus 100 further includes the controller 17, the sensors 51-1 to 51-N (N is an integer of 1 or greater), the communication unit 52, the ROM 53, the RAM 54, the analog-to-digital (A/D) converters 55 and 56, the A/D converters 57-1 to 57-N, the main motor 60, the fixing device motor 61, the high voltage power supply 62, the motor 63, and the driving circuits 64 to 70. Hereinafter, when the sensors 51-1 to 51-N are not particularly distinguished, the sensor is simply described as the sensor 51. Hereinafter, when the A/D converter is not distinguished among the A/D converters 57-1 to 57-N, the A/D converter is simply described as the A/D converter 57.

The controller 17 includes a CPU (Central Processing Unit). The controller 17 controls operations of the image forming apparatus, including an operation to control the temperature of the fixing device 20. Input devices connected to the controller 17 include the HR thermistor 24, the pressure belt thermistor 31, the sensor 51, the control panel 120, and the communication unit 52. Output devices connected to the controller 17 include the HR center lamp 22, the HR side lamp 23, the pressure belt lamp 29, the main motor 60, the fixing device motor 61, the high voltage power supply 62, and the motor 63.

First, the input devices connected to the controller 17 will be described below. The HR thermistor 24 outputs a signal to the controller 17 via the A/D converter 55. The HR thermistor 24 outputs a signal indicating the temperature of the surface of the heat roller 21 to the controller 17. The pressure belt thermistor 31 outputs a signal to the controller 17 via the A/D converter 56. The pressure belt thermistor 31 outputs a signal indicating the temperature of the surface of the pressure belt 25 to the controller 17.

The sensor 51 measures physical quantity that is used for controlling the image formation. The sensor 51 outputs a signal indicating the measured physical quantity to the controller 17 via the A/D converter 57. The sensor 51 measures, for example, physical quantity such as the position of a sheet, the thickness of the sheet, the size of the sheet, and the position of the tray.

The control panel 120 and the communication unit 52 are input interfaces that input image-forming instructions from a user. The control panel 120 outputs a signal indicating an image-forming instruction input from a user to the controller 17. For example, the control panel 120 outputs an image-forming instruction from a user. In this case, the controller 17 causes the printer device 33 to form an image in accordance with the image-forming instruction from the user. The communication unit 52 performs communication with an external apparatus. The communication unit 52 may perform communication with the external apparatus in a wired manner or a wireless manner. The external apparatus is, for example, an information terminal such as a computer. The communication unit 52 receives a signal indicating an image-forming instruction from a user and outputs the signal to the controller 17.

Next, the output devices connected to the controller 17 will be described below. The controller 17 controls the operation of the HR center lamp 22 via the driving circuit 64. The controller 17 controls the temperature of the heat roller 21 by controlling an operating time of the HR center lamp 22, for example.

The controller 17 controls the temperature of the fixing device 20 by controlling the temperature of the heat roller 21 and the temperature of the pressure belt 25. The controller 17 controls the operation of the HR side lamp 23 via the driving circuit 65. For example, the controller 17 controls the temperature of the heat roller 21 by controlling an operating time of the HR side lamp 23. The controller 17 may control the temperature of the heat roller 21 by controlling the output power of the HR side lamp 23.

The controller 17 controls the operation of the pressure belt lamp 29 via the driving circuit 66. The controller 17 controls the temperature of the pressure belt 25 by controlling the operating time of the pressure belt lamp 29, for example.

The controller 17 controls the operation of the main motor 60 via the driving circuit 67. The controller 17 controls the operation of the fixing device motor 61 via the driving circuit 68. The controller 17 controls the operation of the high voltage power supply 62 via the driving circuit 69. The controller 17 controls the operation of the motor 63 via the driving circuit 70. The driving circuits 64 to 70 each include a switching circuit, a digital-to-analog (D/A) converter, or the like.

The main motor 60 causes a photosensitive drum of each of the image forming units 12 to 15 to rotate through a driving mechanism. The fixing device motor 61 causes the heat roller 21 to rotate through a driving mechanism. The high voltage power supply 62 and the motor 63 perform an operation for forming an image. In FIG. 3, one high voltage power supply 62 and one motor 63 are illustrated, but a plurality of high voltage power supplies 62 and a plurality of motors 63 may be provided.

The ROM 53 is connected to the controller 17. The ROM 53 stores a control program and control data. The RAM 54 is connected to the controller 17. The RAM 54 stores a control parameter and operation data of the image forming apparatus 100. Examples of the operation data include driving time of each of the photosensitive drums 12b, 13b, 14b, and 15b, the number of printed sheets, and the like.

The photosensitive drums 12b to 15b and the developer devices 12a to 15a are expendable components. In other words, the image forming apparatus 100 includes a plurality of expendable components. The expendable components are components of the image forming apparatus 100 including elements, units, and the like expendable in image formation. In other words, the expendable components are components that operate during image formation. Therefore, not only the photosensitive drums 12b to 15b and the developer devices 12a to 15a, but also the belts, the rollers, the motors, and the like for conveying sheets are the expendable components. In the present embodiment, the RAM 54 stores the driving time of the photosensitive drums and the driving time of the developer devices as operation data. By storing the driving time, the image forming apparatus 100 is capable of determining whether the end-of-life of each of the photosensitive drums 12b to 15b and the developer devices 12a to 15a is getting closer or not.

According to the present embodiment, the image forming apparatus 100 performs the following control in order to give longer lives to the photosensitive drums and the developer devices. Firstly, for example, when an image-forming instruction is input from the control panel 120, the image forming apparatus 100 changes the above-mentioned target temperature of the fixing device 20 to a target temperature corresponding to the image-forming instruction. Note that, where it is not necessary to change the target temperature of the fixing device 20, the image forming apparatus 100 does not change the target temperature, as a matter of course.

The image forming apparatus 100 starts image-forming process after the above-mentioned target temperature of the fixing device 20 is changed to a new target temperature and then the temperature of the fixing device 20 rises or lowers to reach a predetermined temperature (predetermined temperature range) before returning to the above-mentioned new target temperature. The image-forming process includes the process of driving the photosensitive drums and the developer devices. It takes time to change (raise or lower) the temperature of the fixing device 20 to reach the target temperature. Specifically, it takes longer time to lower the temperature of the fixing device 20 than to raise the temperature of the fixing device 20. For example, where the target temperature of the fixing device 20 in a standby status is set at a target temperature corresponding to an image-forming-on-regular-sheet instruction and the control panel 120 inputs an image-forming-on-thick-sheet instruction, it is necessary to lower the temperature of the fixing device 20. This is because the target temperature of the fixing device 20 corresponding to an image-forming-on-thick-sheet instruction is lower than the target temperature of the fixing device 20 corresponding to an image-forming-on-regular-sheet instruction. It sometimes takes several seconds to lower the temperature of the fixing device 20.

For example, if the photosensitive drums and the developer devices are driven before the temperature of the fixing device 20 reaches the above-mentioned predetermined temperature, idling time of several seconds is generated. Since such idling time is also stored as driving time of the photosensitive drums, the photosensitive drums have shorter lifetime. Further, when the photosensitive drums are caused to idle, toners likely to couple each other on the photosensitive drums, electrically chargeable properties is reduced, print density is unstable, and other problems occur. Further, a magnetic brush (not illustrated) for a developer device being in contact with a photosensitive drum scrapes a photosensitive drum, which is also a problem.

In view of this, as described above, according to the present embodiment, the image forming apparatus 100 starts an image-forming process after the temperature of the fixing device 20 reaches the above-mentioned predetermined temperature to thereby give longer lives to the photosensitive drums and the developer devices. Hereinafter, how the image forming apparatus 100 controls operations in an image-forming process of forming an image on a regular sheet and in an image-forming process of forming an image on a thick sheet will be described, for example. Note that the process of forming an image on a regular sheet will sometimes be referred to as “regular sheet mode”, and the process of forming an image on a thick sheet will sometimes be referred to as “thick sheet mode”. In the present embodiment, it is assumed that the image forming apparatus 100 operates in one of the print modes, i.e., the regular sheet mode and the thick sheet mode. Note that, as described above, it is necessary to change the target temperature of the fixing device where the target temperature of the fixing device 20 in a standby status is set at a target temperature corresponding to an image-forming-on-regular-sheet instruction in some other modes. Examples of such modes include, for example, an erasable toner print mode and the like. The erasable toner print mode means a process of forming an image by using erasable toners. Especially, it is necessary to perform a fixing process on erasable toners at a temperature lower than the temperature of the fixing process on non-erasable toners (regular toners). Further, also in an erasing mode, in which the fixing device is used as an erasing device, it is necessary to change the target temperature of the fixing device in the standby status. Note that to change the temperature in the erasing mode is not to change the temperature of the fixing device in order to fix an image. The erasing mode means a process of heating a sheet, on which an image is formed by using erasable toners, to thereby erase the image.

The range of the target temperature TC of the fixing device 20 in the thick sheet mode is T1≦TC≦T2. The range of the target temperature TN of the fixing device 20 in the regular sheet mode is T3≦TN≦T4. Further, for example, T2<T3 is satisfied. In other words, it is assumed that the target temperature range of the thick sheet mode is lower than the target temperature range of the regular sheet mode. Further, the target temperature TW of the fixing device 20 in the standby status is T3≦TW≦T4. In other words, the target temperature TW of the fixing device 20 in the standby status is set at the target temperature of the regular sheet mode. Therefore, where an image-forming instruction of the regular sheet mode is input, the image forming apparatus 100 is capable of forming an image immediately.

In the standby status, where an image-forming instruction of the thick sheet mode is input, the image forming apparatus 100 changes the target temperature T of the fixing device 20 to the target temperature (range of T1≦T≦T2) of the thick sheet mode. The temperature of the target temperature TW of the fixing device 20 in the standby status is higher than the target temperature of the thick sheet mode. In the following description, the controller 17 controls the temperature of the fixing device 20 to change the target temperature T of the fixing device 20 to the target temperature (T1≦T≦T2) of the thick sheet mode.

As described above, the HR thermistor 24 outputs a signal indicating the temperature of the surface of the heat roller 21 to the controller 17. Further, the pressure belt thermistor 31 outputs a signal indicating the temperature of the surface of the pressure belt 25 to the controller 17. The controller 17 receives the signal indicating the temperature of the surface of the heat roller 21 and the signal indicating the temperature of the surface of the pressure belt 25, and controls the temperature of the fixing device 20 on the basis of the signals.

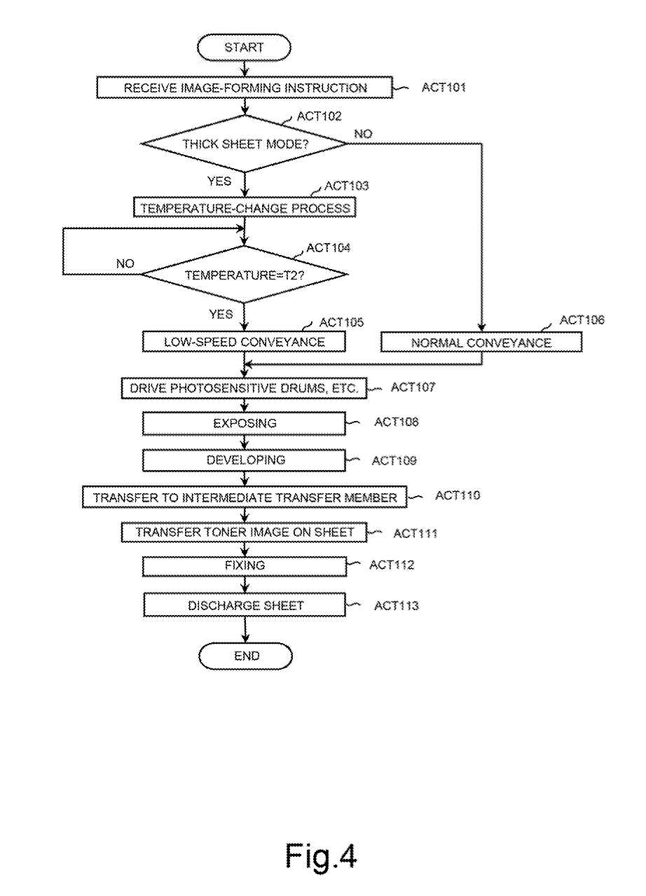

FIG. 4 is a flowchart showing the flow of the image-forming process by the image forming apparatus 100. In FIG. 4, the controller 17 receives an image-forming instruction input from the control panel 120. As described above, the image-forming instruction includes information indicating a print mode (ACT101). In other words, an image-forming instruction input from the control panel 120 includes information indicating the kind of a sheet. The controller determines whether print mode of the received image-forming instruction is the thick sheet mode or not (ACT102).

Where the print mode is not the thick sheet mode (ACT102: NO), the controller 17 conveys a sheet from the sheet-feeding device 18 in a normal way (ACT106), and proceeds to the process of ACT107. Note that the normal conveyance means to convey a sheet at a conveying speed of forming an image in the regular sheet mode. The conveying speed of the normal conveyance is faster than the conveying speed of the low-speed conveyance (described later).

Where the print mode is the thick sheet mode (ACT102: YES), the controller 17 performs the temperature-change process of changing the target temperature of the fixing device 20 (ACT103). The temperature-change process includes the process of changing the target temperature of the fixing device 20 to a target temperature corresponding to the image-forming instruction. Further, the temperature-change process includes the process of raising or lowering the temperature of the fixing device 20 until the temperature of the fixing device 20 reaches the target temperature.

For example, where the temperature of the fixing device 20 is higher than the target temperature, the controller 17 turns off the HR center lamp 22, the HR side lamp 23, and the pressure belt lamp 29. In addition, the controller 17 controls the heat roller 21 and the like to rotate. Further, the controller 17 lowers the temperature of the fixing device 20 by using a fan, for example. Further, for example, where the temperature of the fixing device 20 is lower than the target temperature, the controller 17 turns on the HR center lamp 22, the HR side lamp 23, and the pressure belt lamp 29 to thereby raise the temperature of the fixing device 20.

After the above-mentioned temperature-change process (ACT103), the controller 17 determines whether the temperature of the fixing device 20 reaches T2 or not (ACT104). The temperature T2 is a predetermined temperature before the temperature of the fixing device 20 reaches the target temperature TC of the thick sheet mode. The temperature T2 includes, for example, the temperature immediately before the target temperature and the border values of the target temperature range. In ACT104 of FIG. 4, the temperature T2 is a border value of the target temperature TC (T1≦TC≦T2). Where the temperature of the fixing device 20 reaches the predetermined temperature T2 in the temperature-change process (ACT104: YES), the controller 17 conveys a sheet from the sheet-feeding device 18 at a low-speed (ACT105). Note that the low-speed conveyance means to convey a sheet at a conveying speed of forming an image in the thick sheet mode.

The controller 17 drives the photosensitive drums 12b, 13b, 14b, and 15b (ACT107). In ACT107, the controller 17 further drives the developer devices 12a, 13a, 14a, and 15a.

Next, for example, at a time when the temperature of the fixing device 20 reaches the target temperature TC, the controller 17 controls the charging devices 12c, 13c, 14c, and 15c to operate. Further, the controller 17 controls the exposing devices 12d, 13d, 14d, and 15d to operate. The controller 17 controls the exposing devices 12d, 13d, 14d, and 15d to operate on the basis of image data of the respective colors to thereby expose the photosensitive drums 12b, 13b, 14b, and 15b to light (ACT108). The controller 17 controls the developer devices 12a, 13a, 14a, and 15a to develop electrostatic latent images (ACT109). The toner images developed and formed on the photosensitive drums 12b, 13b, 14b, and 15b are primary-transferred to the intermediate transfer member 10 by means of the field effect, for example (ACT110).

The secondary transfer rollers 16 transfers the toner images, which are transferred to the intermediate transfer member 10, to a sheet (ACT111). The fixing device 20 heats and presses the toner images, which is transferred to the sheet, to thereby fix the toner images on the sheet (ACT112). The controller 17 discharges the sheet, on which the images (toner images) are fixed, to the discharge tray (ACT113).

As shown in FIG. 4, an image-forming instruction is input in the image forming apparatus 100 from the control panel 120, the controller 17 changes the target temperature of the fixing device 20 in the standby status to a new target temperature corresponding to the image-forming instruction (thick sheet mode). Further, the controller 17 changes (lowers) the temperature of the fixing device 20 to the new target temperature (see ACT103). Where the target temperature of the fixing device 20 is changed to the new target temperature and thereafter the temperature of the fixing device 20 reaches the above-mentioned predetermined temperature T2 before the temperature of the fixing device 20 reaches the target temperature, the image forming apparatus 100 starts to convey a sheet (see ACT106) and, in addition, drives the photosensitive drums and the developer devices (see ACT107) to thereby start the image-forming process.

In this way, after the target temperature of the fixing device 20 is changed and then the temperature of the fixing device 20 reaches the predetermined temperature T2, the image forming apparatus 100 starts driving of the photosensitive drums and the developer devices for the image-forming process. Therefore the image forming apparatus 100 is capable of give longer lives to the expendable components (the photosensitive drums and the developer devices). For example, it is assumed that it takes 3 seconds for the temperature of the fixing device 20 to reach the predetermined temperature T2. Further, it is assumed that the target temperature is changed 100 times a day. Then the image forming apparatus 100 is capable of give longer lives to the expendable components by 300 seconds a day. In addition, the image forming apparatus 100 is capable of reducing power consumption of 300 seconds a day.

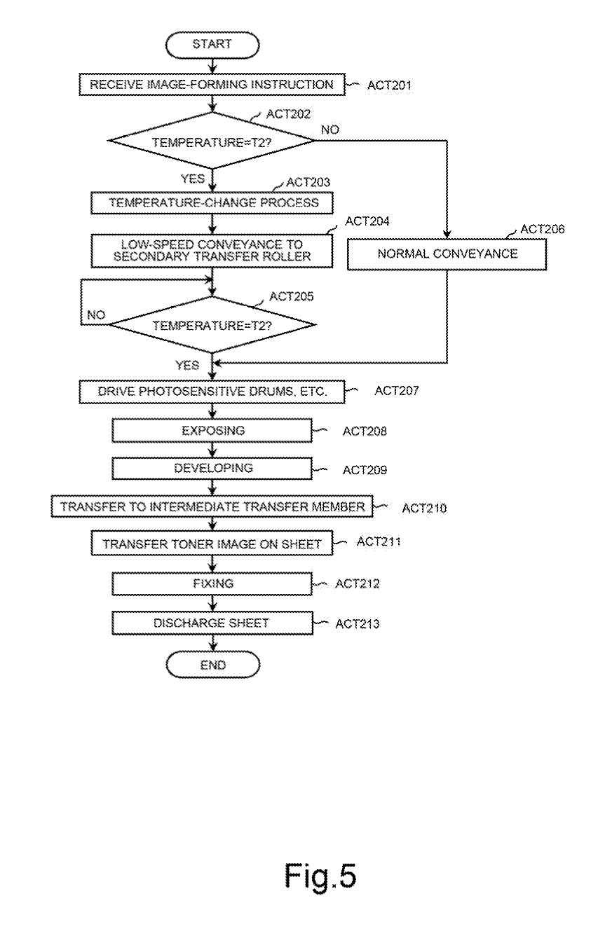

FIG. 5 is a flowchart showing the flow of the image-forming process by the image forming apparatus 100. The process of FIG. 5 is a modification example of the process of FIG. 4. In the process of FIG. 4, after the temperature of the fixing device 20 reaches the predetermined temperature T2, the controller 17 conveys a sheet from the sheet-feeding device 18 (see ACT105). To the contrary, in the process of FIG. 5, before the temperature of the fixing device 20 reaches the predetermined temperature T2, the controller 17 conveys a sheet from the sheet-feeding device 18 to the secondary transfer rollers 16.

ACT201, ACT202, and ACT206 of the process of FIG. 5 are the same as ACT101, ACT102, and ACT106 of the process of FIG. 4, respectively. Further, ACT207 to ACT213 are the same as ACT107 to ACT213, respectively. So the process of ACT203 to ACT205 will be described.

Where the print mode is the thick sheet mode (ACT202: YES), the controller 17 performs the above-mentioned temperature-change process of changing the target temperature of the fixing device 20 (ACT203). The controller 17 conveys a sheet from the sheet-feeding device 18 to the secondary transfer rollers 16 at a low-speed (ACT204). As a result, the sheet stands by in front of the secondary transfer rollers 16 until the temperature of the fixing device 20 reaches the above-mentioned predetermined temperature T2. After that, when the temperature of the fixing device 20 reaches the above-mentioned predetermined temperature T2, the controller 17 performs the process of ACT207 to ACT210, and transfers toner images to the standby sheet of ACT211.

As described above, the controller 17 starts to convey a sheet from the sheet-feeding device 18 before the temperature of the fixing device 20 reaches the above-mentioned predetermined temperature T2. The conveyed sheet stands by in front of the secondary transfer rollers 16 (for example, the position of the resist rollers 32) until the temperature of the fixing device 20 reaches the predetermined temperature T2. As a result, it takes a shorter time to finish the image-forming process.

Note that the above-mentioned embodiment describes an example of the process in which it is determined that, on the basis of the image-forming instruction, it is necessary to change the target temperature of the fixing device 20. To the contrary, in some cases, the temperature of the fixing device 20 is below the target temperature when it is not necessary to change the target temperature corresponding to an image-forming instruction. For example, sheets take heat from the fixing device 20 when images are formed successively. In such a case, the controller 17 suspends the image-forming process by the printer device 33. The controller 17 controls the printer device 33 to start the image-forming process by the printer device 33 where the controller determines that the temperature of the fixing device reaches a predetermined temperature before returning to the target temperature, i.e., before the temperature of the fixing device 20 reaches the target temperature. This is because the temperature of the fixing device 20 reaches the target temperature before a sheet is conveyed to the fixing device 20 since the temperature of the fixing device 20 reaches the target temperature in a relatively short time. Further, this is because the photosensitive drums and the like are less expended since the photosensitive drums and the like are driven only in a short time. As a result, it takes a short time to finish the image-forming process.

In the above-mentioned embodiment, the control panel 120 inputs an image-forming instruction. In an alternative embodiment, for example, a PC (Personal Computer), a mobile terminal, or the like may input an image-forming instruction via communication. In this case, the communication unit 52 is an example of an input interface.

The image forming apparatus of the above-mentioned embodiment can give longer lives to expendable components.

A computer may realize the functions of the image forming apparatus of the above-mentioned embodiment. In this case, a non-transitory computer readable recording medium may store a program for realizing those functions, and a computer system may read the program stored in the recording medium and execute the program to thereby realize those functions. Note that, herein, the “computer system” includes an OS or hardware such as peripheral devices. Further, the “non-transitory computer readable recording medium” means a flexible disk, a magneto-optical disk, a ROM, a mobile medium such as a CD-ROM, a memory device such as a hard disk built in the computer system. Further, the “non-transitory computer readable recording medium” may also mean a recording medium that stores the program instantly and dynamically, such as a communication line, where the program is sent via a network such as the Internet or a communication line such as a telephone line. In this case, the “non-transitory computer readable recording medium” may also mean a recording medium that stores the program for a predetermined time period, such as a volatile memory in a computer system such as a server or a client. Further, the above-mentioned program may realize part of the above-mentioned functions, and may realize the above-mentioned functions on the basis of combination with a program already recorded in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form according to the present embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a printer device that forms an image on a sheet;
a fixing device that heats the sheet, on which the image is formed by the printer device, at a variable target temperature to thereby fix the image on the sheet;
an input interface that inputs an image-forming instruction; and
a controller that
determines whether it is necessary to change the target temperature of the fixing device on the basis of the image-forming instruction input from the input interface,
executes a temperature-change process where the controller determines that it is necessary to change the target temperature of the fixing device, the temperature-change process including changing the target temperature of the fixing device to a new target temperature, and
controls the printer device to start an image-forming process on the basis of the image-forming instruction after the temperature-change process.

2. The image forming apparatus according to claim 1, wherein
the printer device includes a plurality of expendable components, and forms the image on the sheet by driving the plurality of expendable components, and
the image-forming process includes driving at least part of the plurality of expendable components.

3. The image forming apparatus according to claim 2, wherein
the at least part of the expendable components are components expended when the printer device forms the image.

4. The image forming apparatus according to claim 3, wherein
the printer device includes, as the plurality of expendable components,
an image holding member,
a charging device that electrically charges the image holding member uniformly,
an exposing device that exposes the image holding member electrically charged by the charging device to light to thereby form an electrostatic latent image on the image holding member,
a developer device that causes toner to adhere to the image holding member, on which the electrostatic latent image is formed by the exposing device, to thereby form a toner image on the image holding member, and
a transfer device that transfers the toner image to the sheet to thereby form the image on the sheet.

5. The image forming apparatus according to claim 4, wherein
the at least part of the expendable components includes the image holding member.

6. The image forming apparatus according to claim 1, further comprising:
a sheet-feeding device that conveys the sheet to the printer device, wherein
the controller controls the sheet-feeding device to start conveying the sheet before the temperature-change process is completed.

7. The image forming apparatus according to claim 1, wherein
the controller controls the printer device to
suspend the image-forming process by the printer device where the temperature of the fixing device is below the target temperature when the printer device is executing the image-forming process and the image is fixed to the sheet by the fixing device, and
start the image-forming process by the printer device where the controller determines that the temperature of the fixing device reaches a predetermined temperature before returning to the target temperature.

8. The image forming apparatus according to claim 1, wherein
the temperature-change process further includes raising or lowering a temperature of the fixing device to the new target temperature, and
the controller controls the printer device to start the image-forming process where the controller determines that the temperature of the fixing device reaches a predetermined temperature before returning to the new target temperature.

9. The image forming apparatus according to claim 1, wherein
the image-forming instruction input from the input interface includes information indicating a kind of the sheet, on which the image is to be formed, and
the controller determines whether it is necessary to change the target temperature of the fixing device on the basis of the information indicating a kind of the sheet in the image-forming instruction.

10. The image forming apparatus according to claim 1, wherein
the printer device includes a plurality of expendable components, and forms the image on the sheet by driving the plurality of expendable components,
the temperature-change process further includes raising or lowering a temperature of the fixing device to the new target temperature, and
the controller
drives at least part of the plurality of expendable components where the controller determines that the temperature of the fixing device reaches a predetermined temperature before returning to the new target temperature, and
drives rest of the expendable components out of the plurality of expendable components where the controller determines that the temperature of the fixing device reaches the new target temperature.

11. An image forming method by an image forming apparatus including a printer device that forms an image on a sheet, a fixing device that heats the sheet, on which the image is formed by the printer device, at a variable target temperature to thereby fix the image on the sheet, and an input interface that inputs an image-forming instruction, the image forming method comprising:
determining whether it is necessary to change the target temperature of the fixing device on the basis of the image-forming instruction input from the input interface;
executing a temperature-change process where it is determined that it is necessary to change the target temperature of the fixing device, the temperature-change process including changing the target temperature of the fixing device to a new target temperature; and
controlling the printer device to start an image-forming process on the basis of the image-forming instruction after the temperature-change process.
